(19) United States
(12) Patent Application Publication
(10) Pub. No.: US 2025/0025727 A1
(43) Pub. Date: Jan. 23, 2025

(54) SYSTEMS AND METHODS OF SPRINKLER SPRING SEALS HAVING CERAMIC COATINGS

(71) Applicant: Tyco Fire Products LP, Cranston, RI (US)

(72) Inventors: Vivekanandan S, Chennai (IN); Bharani Kannan, Chennai (IN)

(73) Assignee: Tyco Fire Products LP, Cranston, RI (US)

(21) Appl. No.: 18/775,135

(22) Filed: Jul. 17, 2024

(30) Foreign Application Priority Data
Jul. 20, 2023 (IN) 202341048876

(51) Int. Cl. A62C 37/11; F16K 25/00; F16K 31/00

(52) U.S. Cl. CPC A62C 37/11; F16K 25/005; F16K 31/002

(57) ABSTRACT

A sprinkler includes a body, at least one frame arm extending from the body, a deflector coupled with the at least one frame arm, a seal, and a thermal trigger between the deflector and the seal. The seal has a sol-gel material coating. The thermal trigger is to allow the seal to be released from the outlet responsive to a fire condition.

### CROSS-REFERENCE TO RELATED APPLICATIONS

The present application claims the benefit of and priority to Indian patent application No. 202341048876, filed Jul. 20, 2023, the disclosure of which is incorporated herein by reference in its entirety.

### BACKGROUND

Sprinklers can be used to respond to fires by providing fluids, such as water, to address the fire. For example, sprinklers can deliver fluid from a fluid supply when the sprinkler opens to address the fire.

### SUMMARY

At least one aspect relates to a sprinkler. The sprinkler can include a body, at least one frame arm extending from the body, a deflector coupled with the at least one frame arm, a seal, and a thermal trigger between the deflector and the seal. The seal has a sol-gel material coating. The thermal trigger is to allow the seal to be released from the outlet responsive to a fire condition.

At least one aspect relates to a seal assembly of a sprinkler. The seal assembly can include a sprinkler button of metal. A seal made of metal can be coupled with the sprinkler button, the seal is of metal. The seal assembly can include a sol-gel material coating on the seal.

At least one aspect relates to a seal. The seal can include an annular disc of metal, the disc having a first side and a second side and forming a central opening. The seal can include a sol-gel material coating on the first side and the second side. The coating can include a metal oxide.

At least one aspect relates to a method of manufacturing a sprinkler. The method can include providing a seal. The method can include applying a coating of a sol-gel material, such as a ceramic or a metal oxide, on the seal. The method can include coupling the seal with a sprinkler.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of a sprinkler.

FIG. 2 is a cross-section view of a seal of a sprinkler.

FIG. 3 is a flow diagram of a method of manufacturing a sprinkler.

### DETAILED DESCRIPTION

Before turning to the figures, which illustrate certain examples, it is noted that the present disclosure is not limited to the details or methodology set forth in the description or illustrated in the figures. The terminology used herein is for the purpose of description only and should not be regarded as limiting.

The present disclosure relates generally to the field of fire sprinklers. More particularly, the present disclosure relates to systems and methods of sprinkler seals having ceramic coatings, such as sol-gel coatings.

Fire protection systems include sprinklers that can inhibit or permit flow of fluid (typically water, but also in some applications fire suppressant fluid) depending upon conditions. In the instance of a fire or detected conditions that may be indicative of a fire (e.g., increased heat, smoke, etc.), the sprinklers can permit the flow of fluid such that the fluid may contact a deflector and be dispersed so as to provide exposure protection to objects in an area, a floor, a window, and/or wall. The sprinklers may disperse water or fire protection fluid over a specific area, for example a portion of a room or hallway, or a window or wall. In order to accomplish fire exposure protection for a given area (e.g., room, hallway, window, wall, etc.), sprinklers can include components that permit flow of fire protection fluid in response to activation of one or more fire sprinklers.

For example, a fire sprinkler may include one or more components that provide a fluid seal, thus preventing passage of fire protection fluid when the fire sprinkler is in an inactivated state. These components may permit passage of fire protection fluid upon activation of the fire sprinkler, thus providing fire protection fluid to the given area.

Fire protection fluid can be supplied to a fire sprinkler via a fluid supply and/or a network of piping. A seal can be provided within the fire sprinkler so as to retain the fire protection fluid within the fluid supply and/or piping until the fire sprinkler is activated. The fire protection fluid can be stored in the fluid supply and/or piping in a pressurized state such that the fire protection will exit the fire sprinkler upon activation at a flow velocity and volumetric flow rate sufficient to provide fire protection or suppression for a desired area.

One or more seals disposed within the fire sprinkler can provide a seal that retains the pressurized fire protection fluid. In various applications, the fire protection fluid may be stored at different pressures and, accordingly, the seals of the fire sprinkler can accommodate the pressurized fluid.

For example, the sprinkler can include a thermal trigger (such as a fusible link that includes two pieces joined together by solder, which melts responsive to increased temperature from a fire, or a glass bulb having a fluid inside that expands responsive to increased temperature from a fire), that breaks responsive to a fire condition. The thermal trigger can be coupled with the seal to apply a load on the seal (or at least a portion thereof) that holds the seal in position to seal the sprinkler. Responsive to the thermal trigger breaking, the seal can be driven away (e.g., ejected) from the position at which the seal seals the sprinkler by fluid pressure from fluid in the sprinkler. This allows the sprinkler to output the fluid to address the fire condition, such as to be directed by a deflector that outputs the fluid according to a target spray pattern.

The seal or seal assembly of a sprinkler can include components such as a spring (e.g., Belleville spring) and sprinkler button. The sprinkler buttons may be made from materials such as stainless steel, phosphor bronze, or copper. The manner in which the sprinkler button is structured can affect the strength and/or rigidity of the seal, which can affect considerations such as deformations, leaks, or cracks, particularly under the pressure (from the fluid in the sprinkler) and temperature (from a developing fire) conditions that the seal operates under. In addition, for the seal to eject effectively out of the path of the fluid flow, relatively hard materials should contact the frame of the sprinkler as the sprinkler button moves.

Some seals including coatings to facilitate sealing (e.g., watertight sealing) and other functions for sprinklers. For example, the seals can be coated with polytetrafluoroethylene (PTFE) (e.g., Teflon coating) or other per- and polyfluroalkyl substance (PFAS) coatings. Various such materials for applying as films to or otherwise coating seals for sprinklers can be useful for fire protection conditions; for example, such materials can have water, oil, and dirt repellency; can be durable under temperature, pressure, radiation, and/or chemical conditions that fire protection systems are used for; and can provide electrical and thermal insulation.

However, PTFE and/or PFAS materials can have various adverse effects. For example, such materials can have adverse health and/or environmental effects. Such materials can persist themselves or, even if they do degrade, degrade into other persistent forms (e.g., into other PFAS materials), such as due to the carbon-fluorine bond in the materials. These materials can also be difficult to remove once released into the environment (e.g., subsequent to becoming treated as waste).

Springs of seals for sprinklers in accordance with the present disclosure can include coatings made from ceramic and/or sol-gel materials. Such materials can have high temperature stability (e.g., to remain in a target phase or state up to 2,000° C.). The coating can protect against corrosion of the seal. The coating can provide wear resistance for the seal. The coating can be non-magnetic and/or non-conductive. The coating can be io-compatible. The coating can have high purity (e.g., can be synthesized in a manner to have few or no chemicals other than those targeted for the structure of the seal). The coating can have a thermal expansion coefficient within a target threshold of the seal. The coating can have the stiffness and/or rigidity of a monolithic ceramic. As such, by implementing the seals using sol-gel coatings (e.g., instead of organic coatings, coatings including carbon-fluorine bonds, PTFE coatings, and/or PFAS coatings), the seals can perform effectively under fire protection conditions while avoiding detrimental effects of PTFE and/or PFAS coatings.

For example, a sprinkler can include a body, at least one frame arm extending from the body, a deflector coupled with the at least one frame arm, a seal, and a thermal trigger between the deflector and the seal. The seal has a sol-gel material coating. The thermal trigger is to allow the seal to be released from the outlet responsive to a fire condition. By forming the coating on the seal using a sol-gel material, such as a metal oxide and/or ceramic material, the sprinkler can be provided without using materials that include carbon-fluorine bonds, such as PTFE and/or PFAS coatings. The seals and/or coatings thereof can be formed in a manner that accounts for various considerations for fire protection operation. For example, to seal effectively, the load pressure on the seal (and thus the load pressure that the seal and/or coating is to be capable of handling) should be greater than the water pressure behind the seal. However, while too load of a load can result in leakage past the seal, too high of a load on the seal can cause the sol-gel coating to be squeezed out or extruded; systems and methods in accordance with the present disclosure can form the coating to account for such considerations.

The seals described herein can be implemented for various fluid distribution devices, including but not limited to sprinklers, devices that include deflectors, devices that include diffusers, or devices that include actuators or other electronically controlled activation elements.

The seals can be used for various fire protection (e.g., fire protection, fire suppression) systems. The fire protection systems can include water or chemical systems. The fire protection systems can distribute a fire suppressant agent onto or nearby a fire, extinguishing the fire and preventing the fire from spreading. The fire protection system can be used alone or in combination with other types of fire protection systems (e.g., a building sprinkler system, a handheld fire extinguisher). Multiple fire protection systems can be used in combination with one another to cover a larger area (e.g., each in different rooms of a building).

The fire protection system and sprinklers thereof can be used in a variety of applications. The fire protection system can be used with a variety of fire suppressant agents, including but not limited to water (e.g., may use powders, liquids, foams, or other fluid or flowable materials). The fire protection system can include or be coupled with a fluid supply. The fluid supply can define an internal volume filled (e.g., partially filled, completely filled) with fire suppressant agent. The fluid supply can provide fluid from a remote location to a building in which the fire protection system is located. Piping (e.g., one or more pipes, tubes, conduits) can be fluidly coupled with one or more sprinklers (or other fluid distribution devices). The sprinklers can receive water or other fire suppressant agent from the fluid supply via the piping. The seals described herein can be used for sprinklers or other fluid distribution devices for any of a variety of applications, including, for example, concealed sprinklers, sidewall sprinklers, storage sprinklers, sprinklers for dry or wet applications, extended coverage sprinklers, early suppression fast response (ESFR) sprinklers, residential sprinklers, commercial sprinklers, or various combinations thereof.

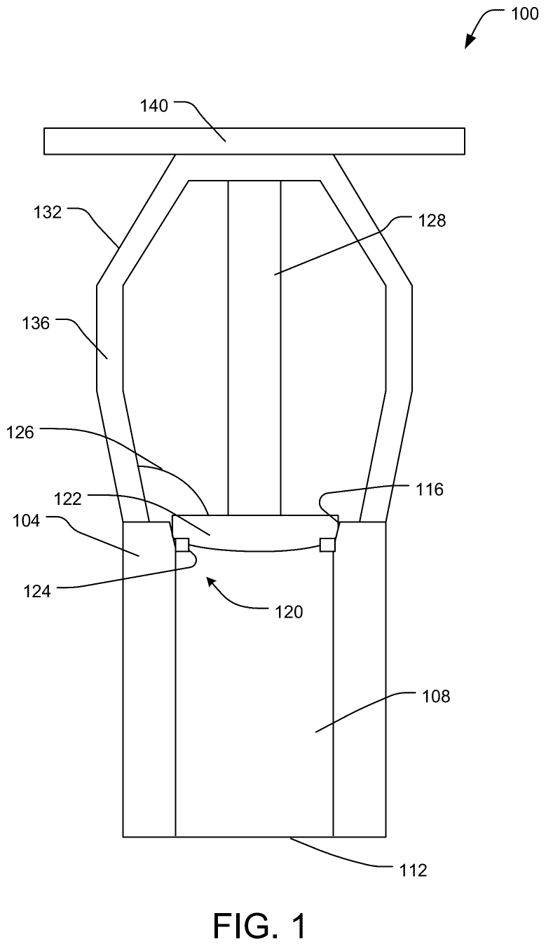

FIG. 1 depicts a sprinkler 100. The sprinkler 100 includes a body 104 defining an internal passageway 108 that extends from an inlet 112 to an outlet 116. The body 104 can be made of various materials, including metallic, polymeric, and/or composite materials.

The inlet 112 can be coupled with one or more pipes coupled with a fluid supply to receive fluid from the fluid supply. The inlet 112 can be coupled with the one or more pipes and/or one or more adapters (e.g., tees, elbows, pipe nipples, etc.) between the sprinkler 100 and the one or more pipes. The body 104 can include threads to couple with pipes and/or adapters. The adapters can include channels and/or seals to receive the sprinkler 100 in threaded and/or push-to-connect connections.

The internal passageway 108 can have a constant inner diameter, or can vary in inner diameter in one or more portions between the inlet 112 and the outlet 116. The outlet 116 can have the same or different diameter as the inlet 112. Various such structural features for the internal passageway 108 can allow for various fluid flow dynamics through the internal passageway 108.

For example, as depicted in FIG. 1, the internal passageway 108 can include at least one shoulder 118 (e.g., a portion of the wall forming the internal passageway 108 varying in diameter relative to another portion of the wall). The shoulder 118 can be used to receive one or more components of a seal assembly 120, such as at least one of sprinkler button 122 and seal 124.

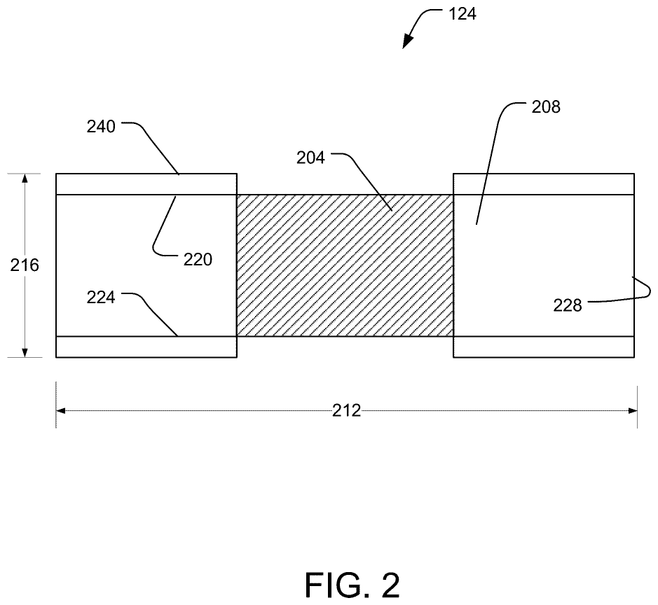

As depicted in FIG. 2, the sprinkler 100 can include a sprinkler button 122 that is received in the outlet 116. The sprinkler button 122 can seal the internal passageway 108 to prevent fluid in the internal passageway 108 from being outputted until a fire condition is detected. The sprinkler button 122 can have an outer diameter equal to or greater than at least a portion of the internal passageway 108, such as a portion of the shoulder 118, to facilitate sealing the internal passageway 108. The sprinkler button 122 can be made of various materials, including but not limited to metal materials.

The sprinkler button 122 can be received in the outlet 116 such that the sprinkler button 122 faces fluid in the internal passageway 108. The sprinkler button 122 can be solid, or can be at least partially hollow, such as by forming a shell. The sprinkler button 122 can be made of material such as copper, stainless steel, phosphor bronze, nickel, titanium, chromium, or an alloy of one or more such materials. The sprinkler button 122 can be made of a corrosion resistant material. For example, the sprinkler button 122 may be made of a nickel and copper alloy (e.g., MONEL) or a nickel and chromium alloy (e.g., INCONEL).

The seal assembly 120 can include at least one seal 124. The seal 124 can include a spring seal, such as a Belleville spring. As depicted in FIG. 1 and FIG. 2, the seal 124 can have an annular shape, such as to be formed as a disc forming an opening 204. The seal 124 can contact the internal passageway 108 (e.g., the shoulder 118) and the button 120. The seal 124 can be compressed by at least one of a force applied by thermal trigger 128 on the button 120 and a force applied by fluid in the internal passageway 108 on the seal 124 to facilitate sealing the internal passageway 108 from the outlet 116. The sprinkler button 122 can be formed as a separate member from the seal 124, or can be formed integrally with the seal 124. For example, the seal assembly 120 can include the sprinkler button 122 and/or seal 124 as a same or integral or monolithic member to which coating 240 is applied.

As depicted in FIG. 2, the seal 124 can include a seal body 208 forming the opening 204. The seal body 208 can be shaped as an annular disc. The seal body 208 can be made of any of various materials, such as metal or composite materials. For example, the seal body 208 can be made from aluminum, steel, or non-ferrous metals. The seal body 208 can have a diameter 212 and a height 216, which can be less than the diameter 212 (e.g., including the thickness of coating 240). The seal body 208 can extend from a first side 220 to a second side 224. As depicted in FIG. 1, the seal 124 can be positioned in contact with the sprinkler button 122 and the shoulder 118; for example, one of the first side 220 or the second side 224 can face the internal passageway 108, and the other of the first side or the second side 224 can face the sprinkler button 122.

The seal 124 can include at least one coating 240. The coating 240 can be disposed along the first side 220, and can be disposed along the second side 224. The coating 240 can be provided along an outer edge 228 of the seal 124, or the outer edge 228 can be exposed (e.g., as depicted in FIG. 2) without being coated. The coating 240 can be relatively thin compared with the height 216, such that a ratio of the thickness of the coating 240 to the height 216 can be between 1:250 and 1:3 (e.g., having a thickness less than thirty percent of the height 216; less than ten percent of the height 216). For example, the coating 240 can be formed as a single layer on at least one of the first side 220 and the second side 224. The coating 240 can be disposed on the seal body 208 by deposition or casting. The coating 240 can have a thickness between 2 to 75 microns (e.g., for the respective layers on the first side 220 and second side 224). The thickness can be greater than or equal to 5 microns and less than or equal to 50 microns. The thickness can be greater than or equal to 8 microns and less than or equal to 35 microns. The thickness can be greater than or equal to 10 microns and less than or equal to 30 microns. The thickness can have a maximum value (e.g., above which the coating 240 may not allow for a proper seal to be formed between the seal body 208 and the internal passageway 108); the maximum value can be, for example, 50 microns. For example, the thickness can be selected (e.g., to have a value greater than or equal to 2 microns and less than or equal to 75 microns; greater than or equal to 6 microns and less than or equal to 50 microns) to allow for effective mechanical engagement between the coating 240 and the internal passageway 108, e.g., without under- or over-tightening. The ratio of the coating 240 to the height 216 can allow for sufficient engagement between the seal body 208 and the internal passageway 108 given a size of the seal body 208.

The coating 240 can include at least one of a ceramic and a sol-gel material. For example, the coating 240 can include a metal oxide, including but not limited to silicon oxides and/or titanium oxides. The sol-gel material can be made by any of various sol-gel processes in which a colloidal solution is dried and/or provided a thermal treatment. For example, the coating can be formed from small inorganic particles suspended in solution that gel together to form an inorganic matrix. The suspended particles can undergo hydrolysis through the addition of water and subsequent condensation polymerization, where molecules join together and form a gel.

The coating 240 can be inorganic, and can be substantially free of materials other than metals or oxides (e.g., no carbon; more than ninety percent metal and oxygen). By forming the coating 240 using a sol-gel process, the coating 240 can be formed with significantly less carbon dioxide generation than PTFE and/or PFAS materials (e.g., at least fifty percent less) per seal 124.

The coating 240 can be applied to the surfaces (e.g., of sides 220, 224) of the seal body 208, and can be dried onto surfaces to form a hard, dense surface. The coating 240 can be applied in a single layer on the seal body 208 or surfaces thereof. The coating 240 can have a high-gloss, glass-like finish, which can be devoid of surface irregularities. As described above, the coating 240 can have various characteristics to perform effectively for fire protection. For example, the coating 240 can have one or more of the toughness, impermeability, and thermal stability of a ceramic, combined with one or more of the chemical inertness, and non-stick properties of a polymeric material.

Various properties of the coating 240 can be controlled according to how the sol-gel process for forming the coating 240 is performed. This can include, for example and without limitation, control porosity, pore size, or other structural aspects of the coating 240 based on how the coating 240 is performed. For example, one or more parameters such as coefficient of thermal expansion, Young's modulus, hardness (e.g., durometer hardness), rigidity, stiffness, spring constant, or various combinations thereof can be determined according to how the material of the coating 240 is formed. For example, various aspects of the sol-gel process (e.g., hydrolysis and polymer condensation; gelation; aging; drying; densification; and/or crystallization) can have their respective parameters controlled (e.g., time, temperature, pressure, solvents or other materials used to support the process steps) according to values targeted to achieve corresponding properties for the coating 240 (e.g., according to experimental data indicative of such values).

For example, a value of the one or more parameters can be within a threshold (e.g., less than twenty percent, less than ten percent, less than five percent, less than one percent) of a corresponding value of the one or more parameters of the seal body 208. By conforming the one or more parameters of the coating 240 with corresponding parameters of the seal body 208, the coating 240 and seal body 208 can effectively operate together for fire protection conditions, while also using characteristics of the coating 240 that facilitate scaling.

As depicted in FIG. 1, for example, the seal can include or be coupled with a spring 126. The spring 126 can be an ejection spring. The spring 126 can contact one or more points on the button 122 (e.g., a side of the button 122 opposite the side of the button 122 facing the internal passageway 108). The spring 126 can facilitate moving the button 122 out of the outlet 116 responsive to a fire condition, such as to cause the button 122 to be deflected off of frame arms 136 by pressure from fluid in the internal passageway 108. The sprinkler 100 may not include the spring 126 and/or may couple the spring 126 with at least one point on the thermal trigger 128 to facilitate moving the thermal trigger 128 out of the path of fluid in the internal passageway 108.

The sprinkler 100 can include a thermal trigger 128 that is coupled with the sprinkler button 122 to apply a load to the sprinkler button 122, such as to hold the sprinkler button 122 in a sealing position for sealing the internal passageway 108. The thermal trigger 128 can be triggered (e.g., actuated) responsive to a fire condition, such as a temperature around the thermal trigger 128 meeting or exceeding a target temperature.

For example, the thermal trigger 128 can include a fusible link that includes at least two members coupled with one another by solder. Responsive to the temperature around the thermal trigger 128 meeting or exceeding the rated temperature, the solder can melt, allowing the at least two members to separate from one another, which can reduce or remove the load applied against the sprinkler button 122 to allow the force from the fluid pressure in the internal passageway 108 on the sprinkler button 122 to eject the sprinkler button 122 away from the outlet 116.

The thermal trigger 128 can include a glass bulb having fluid that expands to a state sufficient to break the glass bulb responsive to the temperature around the thermal trigger 128 meeting or exceeding the target temperature, which can reduce or remove the load applied against the sprinkler button 122 to allow the force from the fluid pressure in the internal passageway 108 on the sprinkler button 122 to eject the sprinkler button 122 away from the outlet 116.

The sprinkler 100 can include a frame 132 coupled with a deflector 140. The frame 132 can extend from the body 104. The frame 132 can include one or more frame arms 136 that extend from the body 104 towards the deflector 140 and around the thermal trigger 128. The sprinkler button 122, when ejected, can strike the frame 132 in a manner so that the sprinkler button 122 (as well as the seal 124) moves away from the sprinkler 100 to allow fluid to flow out of the outlet 116 to the deflector 140 without being obstructed by the sprinkler button 122. The deflector 140 can cause the fluid to be outputted from the sprinkler 100 according to a target spray pattern (e.g., based on the structure of one or more tines of the deflector 140).

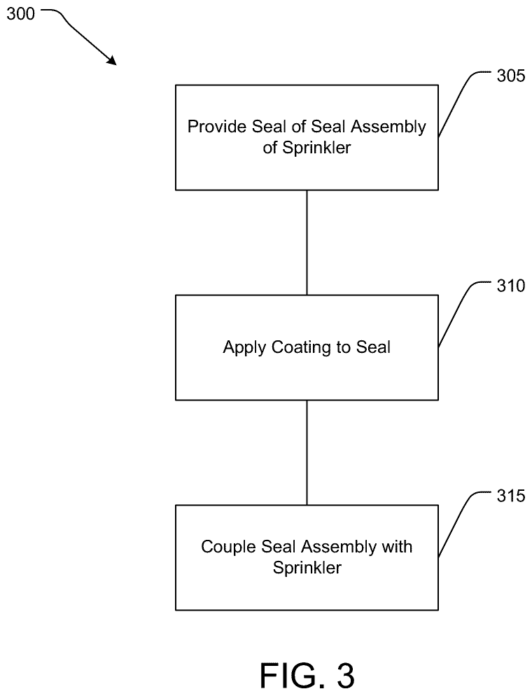

FIG. 3 depicts an example of a method 300 of manufacturing a sprinkler. The method 300 can be used to form various sprinklers or components thereof that are described herein. For example, the method 300 can be used to form the sprinkler 100 to include the seal assembly 120 and/or the coating 240 for the seal 124 of the seal assembly 120.

At 305, a seal of a seal assembly is provided. The seal can be a compressible member, such as a Belleville seal. The seal can be coupled with a sprinkler button. The seal can be made of a metal or composite material. The seal can be provided as an annular disc forming an opening to at least partially receive a sprinkler button of the seal assembly, or can be a planar member or otherwise be free of openings.

At 310, a coating is applied to the seal. The coating can include at least one of a ceramic coating or a coating made using a sol-gel process. For example, the coating can include a metal oxide, such as a silicon oxide or a titanium oxide. The coating can be applied to the seal using at least one of a deposition process or a casting process. The coating can be applied to the seal in a single layer or in a plurality of layers. The coating can be made by a sol-gel process, such as to have one or more properties (e.g., coefficient of thermal expansion) within a threshold of a corresponding property of the seal. The sprinkler button can be separate from the seal, or can be integrally formed with the seal (e.g., such that the coating can be applied to the sprinkler button).

At 315, the seal assembly is coupled with a sprinkler, such as to be coupled with a body of the sprinkler. For example, the seal assembly can be positioned in an outlet of an internal passageway of the sprinkler, such that the seal engages the internal passageway to seal a fluid side of the internal passageway from the outlet. Coupling the seal assembly with the sprinkler can include engaging a thermal trigger with the seal assembly to apply a force against the seal assembly to hold the seal assembly in the outlet (e.g., against a force from pressure of fluid in the internal passageway that can drive the seal assembly out of the outlet in the absence of the thermal trigger).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act, or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical, or other positioning or orientation descriptions include variations within +/−10% or +/−10 degrees of pure vertical, parallel, or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’″′ can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A sprinkler, comprising:
a body having an internal passageway extending between an inlet and an outlet;
at least one frame arm extending from the body;
a deflector coupled with the at least one frame arm;
a seal coupled with the outlet, the seal having a sol-gel material coating; and
a thermal trigger between the deflector and the seal, the thermal trigger to allow the seal to be released from the outlet responsive to a fire condition.

2. The sprinkler of claim 1, comprising:
the coating comprises a ceramic.

3. The sprinkler of claim 1, comprising:
the coating comprises a metal oxide.

4. The sprinkler of claim 1, comprising:
the seal comprises an annular disc on which the coating is disposed.

5. The sprinkler of claim 1, comprising:
the seal comprises an annular disc on which the coating is disposed; and
a ratio of a thickness of the coating to a thickness of the disc is between about 1:250 and 1:100.

6. The sprinkler of claim 1, comprising:
the seal comprises a button and a Belleville spring having a first side and a second side opposite the first side, the coating disposed on the first side and the second side, the first side in contact with fluid in the internal passageway, the second side in contact with the button.

7. The sprinkler of claim 1, comprising:
the seal comprises an annular disc on which the coating is disposed; and
a value of a parameter of the disc is within ten percent of a value of the parameter of the coating, the parameter comprising at least one of a coefficient of thermal expansion, a rigidity, or a stiffness.

8. The sprinkler of claim 1, comprising:
the coating has a greater Durometer hardness than the seal.

9. The sprinkler of claim 1, comprising:
the coating is thermally stable to avoid undergoing a phase change up to at least 1000 degrees Fahrenheit.

10. The sprinkler of claim 1, comprising:
a thickness of the coating is greater than or equal to 5 microns and less than or equal to 35 microns.

11. A seal assembly of a sprinkler, comprising:
a button of metal;
a seal coupled with the sprinkler button, the seal is of metal; and
a sol-gel material coating on the seal.

12. The seal assembly of claim 11, comprising:
the coating comprises at least one of a ceramic or a metal oxide.

13. The seal assembly of claim 11, comprising:
the seal comprises an annular disc on which the coating is disposed.

14. The seal assembly of claim 11, comprising:
the seal comprises an annular disc on which the coating is disposed; and
a ratio of a thickness of the coating to a thickness of the disc is between about 1:100 and 1:250.

15. The seal assembly of claim 11, comprising:
the seal comprises a Belleville spring having a first side and a second side opposite the first side, the coating disposed on the first side and the second side.

16. The seal assembly of claim 11, comprising:
the seal comprises an annular disc on which the coating is disposed; and
a value of a parameter of the disc is within ten percent of a value of the parameter of the coating, the parameter comprising at least one of a coefficient of thermal expansion, a rigidity, or a stiffness.

17. The seal assembly of claim 11, comprising:
the coating has a greater Durometer hardness than the seal.

18. The seal assembly of claim 11, comprising:
the coating is thermally stable to avoid undergoing a phase change up to at least 1000 degrees Fahrenheit.

19. A seal, comprising:
an annular disc of metal, the disc having a first side and a second side and forming a central opening; and
a sol-gel material coating on the first side and the second side, the coating comprising a metal oxide.

20. The seal of claim 19, comprising:
the coating does not include organic material.
